(19) United States
(12) Patent Application Publication
(10) Pub. No.: US 2026/0221142 A1
(43) Pub. Date: Jul. 30, 2026

(54) SPEECH RECOGNITION SYSTEM EMPLOYING AUDIO PROMPT FOR TARGET SPEAKER FOCUS AND RECOGNITION

(71) Applicant: SoundHound AI IP, LLC, Santa Clara, CA (US)

(72) Inventors: Mathieu Hu, Saint-Ouen-Sur-Seine (FR); Anis Khlif, Santa Clara, CA (US); Majid Emami, Cupertino, CA (US); Keyvan Mohajer, Atherton, CA (US)

(73) Assignee: SoundHound AI IP, LLC, Santa Clara, CA (US)

(21) Appl. No.: 19/037,442

(22) Filed: Jan. 27, 2025

(51) Int. Cl. G10L 17/22; G10L 17/02; G10L 25/54

(52) U.S. Cl. CPC G10L 17/22; G10L 17/02; G10L 25/54

(57) ABSTRACT

An audio prompting system is designed to enhance speech recognition performance of a particular target speaker in environments with multiple speakers and/or background noise. The system utilizes a brief audio prompt which is processed into an audio fingerprint of the target speaker. This fingerprint is then used to process and filter audio including multiple speakers and possibly other noise, suppressing audio input from all sources other than the target speaker. The present technology improves automatic speech recognition accuracy from the target speaker in various scenarios, particularly those with multiple speakers or complex noise characteristics.

### FIELD

The technology relates to voice recognition systems and, more particularly, to a system using a brief audio prompt enabling the system to identify a target speaker and filter out other speakers and extraneous noise.

### BACKGROUND

Conventional speech recognition systems often struggle in environments with multiple speakers, background noise, or varying acoustic conditions. Traditional noise cancellation techniques have limitations, especially when competing speakers are equally loud or when noise characteristics are complex. There is a need for a more adaptive and efficient method to improve primary speaker focus and speech recognition accuracy in these challenging scenarios.

### DESCRIPTION OF THE DRAWINGS

FIG. 1 is a schematic representation of an audio prompt system according to embodiments of the present technology.

FIG. 2 is a schematic representation of an audio prompt system according to alternative embodiments of the present technology.

FIG. 3 is a block diagram showing components of an audio prompt system according to embodiments of the present technology.

FIG. 4 is a flowchart showing how to build a target speaker voice fingerprint according to embodiments of the present technology.

FIG. 5 is a flowchart showing operation of the target speaker mask extraction engine according to embodiments of the present technology.

FIG. 6 is a flowchart showing operation of the mask filter engine according to embodiments of the present technology.

FIG. 7 is an illustration of the operation of the audio prompt system for focusing on a target speaker according to embodiments of the present technology.

FIG. 8 is a schematic block diagram of a computing environment according to embodiments of the present technology.

### DETAILED DESCRIPTION

The present technology will now be described with reference to the figures, which in general relate to an audio prompting system designed to enhance speech recognition performance of a particular target speaker in environments with multiple speakers and/or background noise. The system utilizes a brief audio prompt which is processed into an audio fingerprint of the target speaker. This fingerprint is then used to process and filter audio including multiple speakers and possibly other noise, suppressing audio input from all sources other than the target speaker. The present technology improves automatic speech recognition accuracy for the target speaker in various scenarios, particularly those with multiple speakers or complex noise characteristics.

It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

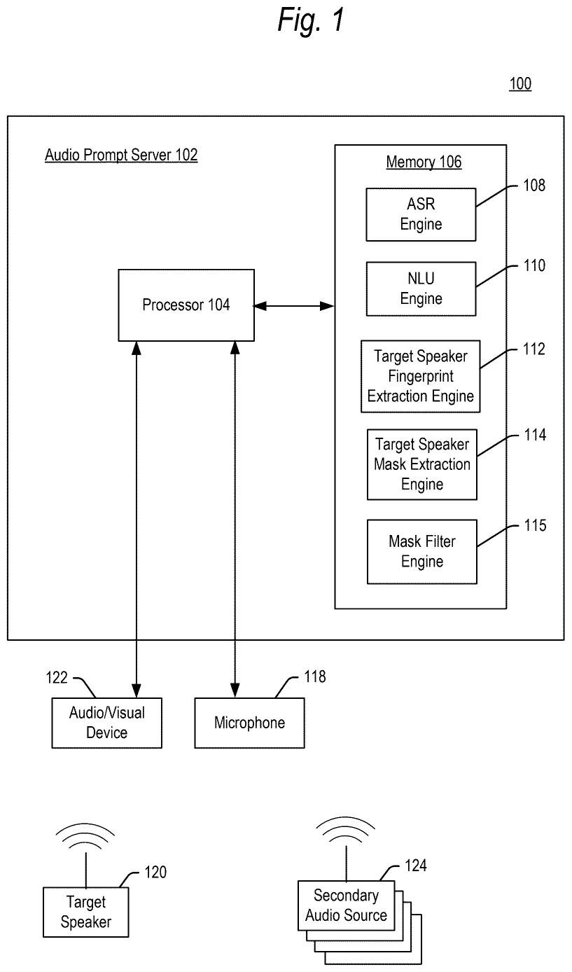

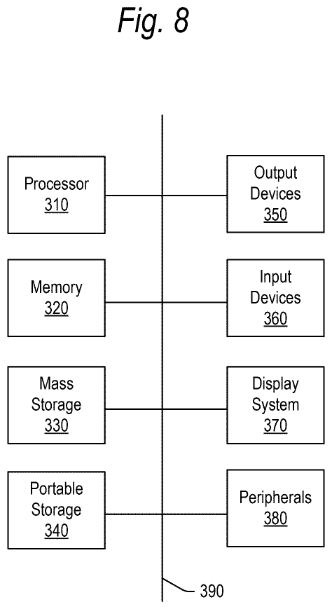

FIG. 1 is a schematic block diagram of a sample audio prompt architecture 100 for implementing the present technology. Architecture 100 may include a server owned, controlled or implemented by an audio prompt voice recognition service provider, referred to herein as audio prompt server 102. In further embodiments, server 102 may be comprised of multiple servers, collocated or otherwise. A more detailed explanation of a sample server 102 is described below with reference to FIG. 8, but in general, server 102 may include a processor 104 configured to control the operations of server 102, as well as facilitate communications between various components within server 102. The processor 104 may include a standardized processor, a specialized processor, a microprocessor, or the like that may execute instructions for controlling server 102.

In further embodiments, processor 104 may be an artificial intelligence (AI) processor configured for example to implement a convolutional neural network which may assist in the voice recognition functionality of the audio prompt server 102. For example, such an AI processor 104 may assist the ASR and/or NLU engines described below in recognizing a target speaker, as well as recognizing and interpreting speech from the target speaker. In further embodiments, the processor 104 may be in communication with a generative AI engine via the Internet.

The server 102 may further include a memory 106 that may store algorithms that may be executed by the processor 104. According to an example embodiment, the memory 106 may include RAM, ROM, cache, flash memory, a hard disk, and/or any other suitable storage component. As shown in FIG. 1, in one embodiment, the memory 106 may be a separate component in communication with the processor 104, but the memory 106 may be integrated into the processor 104 in further embodiments.

Memory 106 may store various software application programs executed by the processor 104 for controlling the operation of the server 102. Such application programs may for example include an automatic speech recognition (ASR) engine 108 and a natural language understanding (NLU) engine 110 for recognizing and interpreting utterances of a target speaker. Memory 106 may further include a target speaker audio fingerprint extraction engine 112 for generating an audio fingerprint of a target speaker. Memory 106 may further include a target speaker mask extraction engine 114 for generating an acoustic mask tuned to the target speakers voice characteristics, and a mask filter engine 115 for filtering incoming audio using the acoustic mask. Each of the engines 108, 110, 112, 114 and 115 are explained in greater detail below. But in general, the engines 108, 110, 112, 114 and 115 cooperate to identify the target speaker, and suppress or filter out all secondary audio sources, to allow better speech recognition with respect to the target speaker. Memory 106 may store additional algorithms in further embodiments.

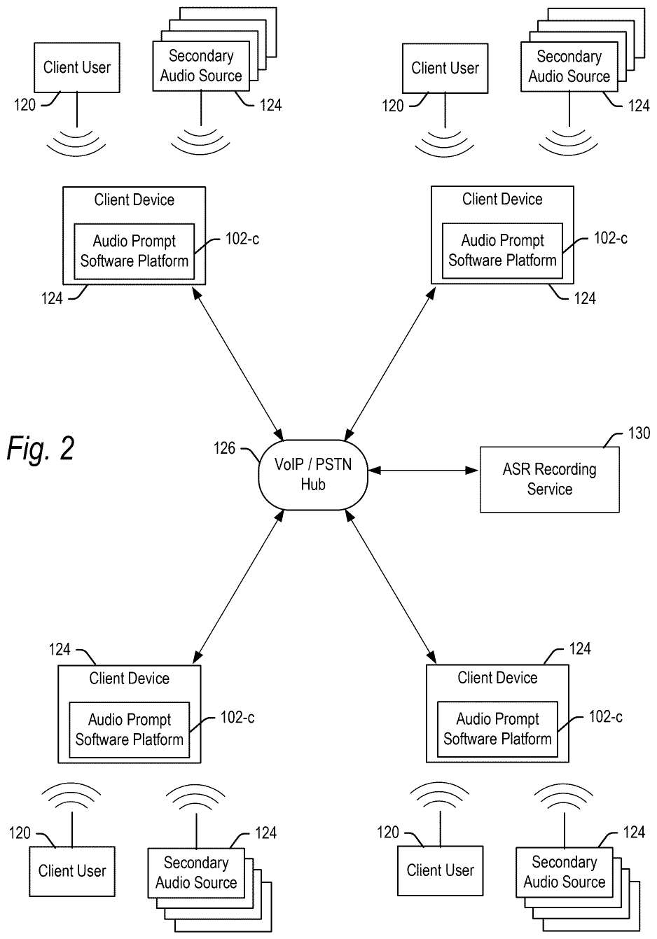

The audio prompt environment 100 of FIG. 2 is one where server 102 is configured to receive audio from multiple users and sources of noise, and the server 102 is able to respond with text and/or speech particularly to utterances of an identified target speaker. A common such environment may be a restaurant drive-through ordering system. In such environments, the server 102 may further include a microphone 118 for receiving audio from the surrounding environment including food orders from a target user 120. The environment may further include an audio/visual device 122 for audibly and/or visibly outputting confirmation of the order as well as other information. In embodiments, the audio/visual device 122 may comprise an order confirmation board, or OCB, for displaying order confirmation and other information as explained below. The server 102 may include additional components for example as described below with respect to FIG. 8.

As noted, the present technology is directed to improved speech recognition for audio received from the target speaker when the microphone 118 is also receiving audio input from one or more secondary audio sources 124. These secondary audio sources may be other people, for example in the same car as the target speaker, or other ambient noises such as music, construction noise, car horns, sirens, wind, rain, thunderstorms, planes and trains, etc. The secondary audio sources may further be noise generated by or within the microphone 118.

While embodiments of the present technology are described with respect to an ordering system used at restaurant drive-through locations, it is understood that the present technology may also or alternatively be used indoors, for example inside a restaurant. In such embodiments, users would interact with the audio prompt server 102 of an automated order taking system, for example while seated at a table or while ordering or conversing at a counter.

The audio prompt system of the present technology may also be used in a variety of service provider facilities other than restaurants. These additional interactive service provider facilities include but are not limited to self-service kiosks for example at airports, grocery store checkout stations, bank ATMs and service windows, hotel check-in and assistance kiosks, pharmacy or retail store kiosks, public transportation kiosks, healthcare facilities, movie theaters, etc.

While embodiments of the present technology are explained in general with respect to in-person interactive systems, it is understood that the present technology may be used in other scenarios. For example, FIG. 2 illustrates a use of the present technology in connection with conference calls or calls between two or more users. In this embodiment, two or more users 120 each have a client device 124 capable of an audio and/or video connection to each other via a central communications hub 126 which may for example be a voice over IP (VoIP) or public switched telephone network (PSTN) hub. The central communications hub 126 may be the Internet in further embodiments. The system of FIG. 2 may further include an ASR recording service 130 for recognizing and transcribing speech, for example to store an audio conversation and/or a text transcription of the audio conversation. As explained below, the ASR recording service 130 may be omitted in further embodiments.

In FIG. 2, each client device 124 may have one or more secondary audio sources 124 in addition to the user (target speaker) 120. In accordance with aspects of the present technology, each client device may include an audio prompt software platform 102-c which performs the same function as audio prompt server 102 of FIG. 1, in the same way as the audio prompt server 102. In particular, at each client device 124, the audio prompt software platform 102-c identifies the client user 120 as the target speaker (as explained below) and effectively removes the other secondary audio sources 124 at the client device 124 (as also explained below). This filters, or removes, the secondary audio sources 124 at each client device, enabling the ASR recording device service 130 to perform its speech recognition and transcription services with minimal word error rates.

In further embodiments, the ASR recording service 130 may be omitted from the environment of FIG. 2. In this embodiment, the audio prompt software platform 102-c at each client device 124 removes the secondary audio source(s) at each client device 124 so that the audio quality from each client device to each other client device is maximized. In this embodiment, the model is trained to remove audio coming from interferences. In this application that primarily targets noise reduction for people (as opposed to improving word-error rates for ASR), the model would output a waveform directly. The training procedures for these two applications (noise reduction for people vs. improving word-error rates for ASR) are similar. The only difference would lie in the output of the model (features vs. waveform) and the loss function used during training.

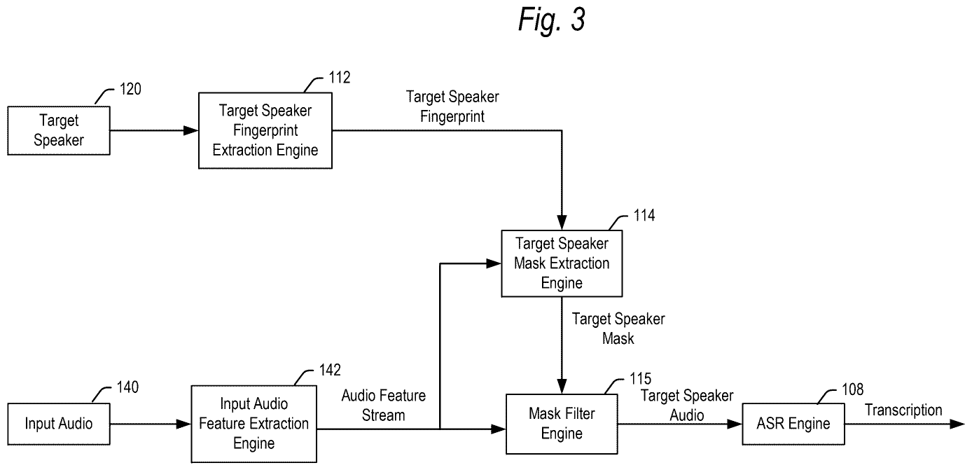

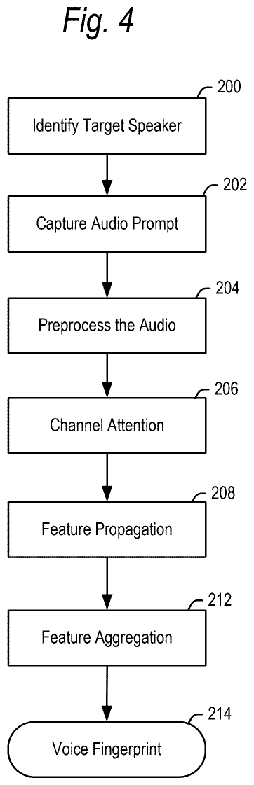

The operation of the audio prompt server will now be explained with reference to the block diagram of FIG. 3 and the flowcharts of FIGS. 4-7. Although not expressly described, the following also applies to the operation of the audio prompt software platform at each of the client devices of FIG. 2. Initially, as shown in FIG. 3 and in step 200 of FIG. 4, a target speaker 120 is identified. This may be done a number of ways. Typically, a target speaker will be the first person to speak. Thus, the voice audio of the first person to speak in a given session may be assigned as the target speaker. Additionally or alternatively, the audio prompt server may look for certain introductory phrases that indicate the speaker is the target speaker. For example, in the context of a drive-through, a person who gives the initial greeting or says something along the lines of “We're ready to order,” may be identified as the target speaker. As noted above, embodiments of the present technology may employ an audio/video device 122 which may be capable of capturing image data. In such embodiments, the A/V device 122 may capture image data of a car at a drive-through, and in particular, the driver of the car. When video of that person speaking is captured, that audio may be used to identify the driver as the target speaker. It is understood that the target speaker may be identified by other or additional methods in further embodiments.

Once the target speaker 120 is identified, an audio prompt is captured from the target speaker in step 202, which audio prompt is used by the target speaker audio fingerprint extraction engine 112 to determine an audio fingerprint of the target speaker. The captured audio prompt may be 3 seconds of audio spoken by the target speaker or more, though the audio prompt may be captured from less than 3 seconds of audio in further embodiments. Ideally, the audio prompt is captured from the target speaker 120 speaking alone, without audio input from the secondary audio sources 124, but it may be captured from audio including the target speaker and one or more secondary audio sources in further embodiments.

In embodiments, the audio prompt is captured from about 3 seconds or more of consecutive (uninterrupted) audio. However, in further embodiments, it may be pieced together from non-consecutive segments of audio. For example, if one or more secondary audio sources speak while the audio prompt is being captured, the target speaker audio fingerprint extraction engine 112 may use audio of the target speaker alone from before and after the interruption by the one or more secondary audio sources, and disregard the audio including the one or more secondary audio sources.

Once the target speaker audio fingerprint extraction engine 112 has the audio prompt, the engine 112 may then compute an audio fingerprint of the target speaker's voice. While this fingerprint may be generated by a variety of methods, in one embodiment, the target speaker audio fingerprint extraction engine 112 may employ Emphasized Channel Attention, Propagation, and Aggregation, or ECAPA. ECAPA uses a convolutional neural network architecture which processes an audio signal and outputs a fixed-dimensional vector. This vector encapsulates unique speaker traits like pitch, timbre, and speech patterns, distinguishing one speaker from another.

ECAPA is a known model, but in general, the target speaker audio fingerprint extraction engine 112 may preprocess the audio data in step 204. This may involve extracting Mel-frequency cepstral coefficients (MFCCs) or Mel spectrogram features from the raw waveform. These features are then normalized to remove variability in amplitude to form feature maps.

In step 206, the engine 112 may use a process called channel attention, taking the feature maps extracted in step 204 and inputting them to a convolutional neural network (possibly within processor 104). The neural network applies channel attention mechanisms to re-scale the feature maps, enhancing the model's focus on the most relevant frequency channels for speaker recognition.

In step 208, the engine 112 performs a feature propagation step which combines features from different convolutional layers through concatenation or summation, preserving both low-level and high-level feature representations. This mechanism enhances the model's ability to capture speaker-specific details while maintaining robustness against variability in the input data.

In step 212, the engine performs a feature aggregation step which aggregates speaker-discriminative information from various layers of the neural network. This allows the model to capture complementary information from different levels of abstraction to combine the features. This aggregated representation is then projected into a compact embedding space, ensuring both efficiency and effectiveness in speaker recognition tasks. These combined features are transformed into a smaller, more compact format that still keeps the important information about the speaker. This makes it easier for the system to recognize speakers accurately and efficiently without needing too much processing power.

The output of the steps of the steps of the flowchart of FIG. 4 (step 214) is an audio fingerprint in the form of a numerical representation of the target speaker's voice characteristics encoded into a fixed-length vector. Each value in this vector captures certain features of the speaker's voice, such as pitch, tone, and unique vocal patterns, while discarding irrelevant information like background noise or specific spoken words. These embeddings are designed to remain consistent for the same speaker across different audio recordings, making them useful for comparing voices. For example, in speaker verification, embeddings from two audio samples are compared; if the embeddings are similar enough, the system concludes they are from the same speaker. This feature of the audio fingerprint is used as described below when filtering audio from multiple sources.

While embodiments of the target speaker audio fingerprint extraction engine 112 operate by the ECAPA model, it is understood that the audio prompt may be processed into the target speaker audio fingerprint by other methods and algorithms in further embodiments. Additionally, the audio fingerprint may be computed to include a variety of time-frequency domain audio features. In one embodiment, these features comprise logarithmically scaled Mel spectrograms. Logarithmically scaled Mel spectrograms are a representation of audio that maps the audio's frequency content to the Mel scale, which mimics how humans perceive pitch, and then applies a logarithmic transformation to the amplitude values. The Mel scale compresses higher frequencies while preserving detail in lower frequencies, aligning with human auditory sensitivity. The logarithmic scaling emphasizes smaller variations in quieter sounds and compresses louder sounds, making the spectrogram more suited to capturing human-relevant patterns for tasks like speech or speaker recognition. The audio fingerprint may be computed to include time-frequency domain features other than, or in addition to, logarithmically scaled Mel spectrograms in further embodiments. Such other time-frequency domain audio features may include linear spectrograms, Mel-Frequency Cepstral Coefficients (MFCCs) and short-time Fourier Transforms (STFTs) to name a few.

After the audio fingerprint is computed, the present system is ready to receive audio from multiple sources and filter out the target speaker from those multiple sources. Referring again to FIG. 3, the audio prompt server 102 may receive an input audio stream 140. This may include the target speaker 120 as well as one or more secondary audio sources 124 (containing one or more additional speakers and possibly noise). This input audio stream is processed by an input audio feature extraction engine 142, which extracts features from the audio stream. The engine 142 may operate by transforming the incoming audio into an audio feature stream suitable for further processing as explained below. This transformation breaks down the audio into a stream of smaller audio feature units, capturing features like frequency and amplitude over time. The audio feature stream may additionally include features indicative of pitch, timbre and/or speech patterns of speakers detected in the input audio.

Where the target speaker fingerprint is computed to include logarithmically scaled Mel spectrograms, the audio feature stream may preferably, though not necessarily, be computed to include logarithmically scaled Mel spectrograms. The audio feature stream may be processed by the input audio feature extraction engine 142 to include linear spectrograms and/or other time-frequency domain representations.

As shown in FIG. 3, the audio feature stream output from the feature extraction engine 142 is input to a target speaker mask extraction engine 114, together with the target speaker audio fingerprint output by the fingerprint extraction engine 112. It is the job of the target speaker mask extraction engine 114 to analyze the incoming audio feature stream and, using the target speaker audio fingerprint, to create a mask isolating the target speaker's voice from the general audio input 140.

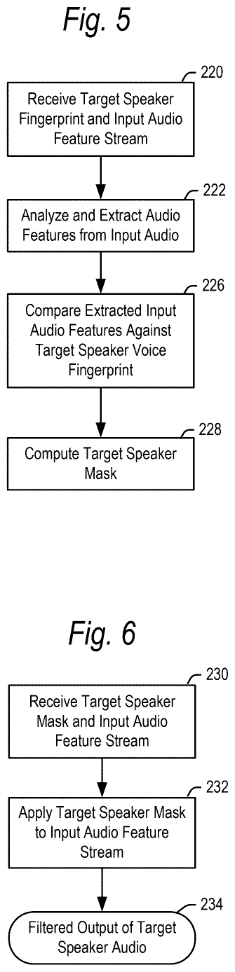

Operation of the target speaker mask extraction engine 114 to isolate the target speaker's voice will now be described with reference to the flowchart of FIG. 5. In step 220, the engine 114 receives the audio feature stream and target speaker audio fingerprint. In step 222, the engine 114 analyzes the inputs. The audio feature stream has a multitude of time-frequency domains, some of which correspond to secondary audio and others that correspond to the target speaker.

In step 226, the engine 114 compares the general audio features in the received stream against the target speaker fingerprint. This comparison involves identifying which parts of the audio input share the time-frequency domain (or other) characteristics of the target speaker. This may for example be done using a convolutional neural network trained to recognize the similarity between the target speaker fingerprint and segments of the audio feature stream.

The neural network used by the target speaker mask extraction engine 114 may be implemented in processor 104 or elsewhere. The neural network may be trained on a variety of data, including challenging data with a lot of overlapping speech from a target speaker and one or more other speakers or secondary audio sources, plus background noise. The neural network may be trained using simple data from a target and one other speaker which may have little or no overlap. The neural network may be trained using the data of pretrained ASR engine 108 as a starting point. Thereafter, ASR loss may be used to guide the training, where ASR loss refers to a measure how well the neural network is identifying speech from the target speaker. It is noted here that the target speaker recognized by the audio prompt server 102 need not appear in the training data of the neural network of the target speaker mask extraction engine, or in any training data of any of the models.

Using the comparison of step 226, the engine 114 generates a mask in step 228. The mask is a time-frequency domain map or filter that highlights the portions of the audio where the target speaker's voice is likely present while suppressing other speakers and noise. For example, the mask may be a set of weights (values between 0 and 1) that indicates how much of each feature in the input audio feature stream belongs to the target speaker. Values close to 1 indicate that a feature likely belongs to the target speaker, while values close to 0 indicate it belongs to noise or another speaker.

Referring now to FIG. 3 and the flowchart of FIG. 6, the input audio feature stream from input audio feature stream extraction engine 142, and the target speaker mask from mask extraction engine 114 are input to a mask filter engine 115 in step 230. The mask is applied to the input features in step 232 to extract only the part of the signal corresponding to the target speaker (step 234). In embodiments using logarithmically scaled Mel spectrograms, this process may involve adding features of the mask to the input audio feature stream, effectively suppressing or filtering out everything that does not match the target speaker. This would include suppressing all secondary audio from other speakers and environmental or ambient noises.

Unlike raw waveforms or linear spectrograms, values in the logarithmically scaled Mel spectrogram domain are logarithmic, so in these embodiments, the mask is added to the input features instead of being multiplied. This ensures that the enhancement process remains mathematically consistent with the logarithmic scale. However, in embodiments which use linear spectrograms and the like, applying the target speaker mask to the input audio stream may involve multiplying the mask with the input features to suppress or filter out all audio other than the target speaker.

The filtered target speaker audio from the mask filter engine 115 is then fed to ASR engine 108 for recognizing the target speaker's audio. The ASR engine 108 outputs a text transcription of the target speaker utterance, which text transcription is subsequently analyzed by the NLU 110 to determine a meaning of, and a subsequent response to, the target speaker utterance. It is noted that the word-error rate of the ASR engine 108 with the target speaker audio processed according technology is significantly lower than it would be if the ASR engine 108 were tasked with recognizing the general audio input 140. Embodiments applying the present technology to recognize speech from a target speaker in an audio stream recognized a nearly 70% reduction in the word-error rate as compared to analysis of the audio stream without the present technology.

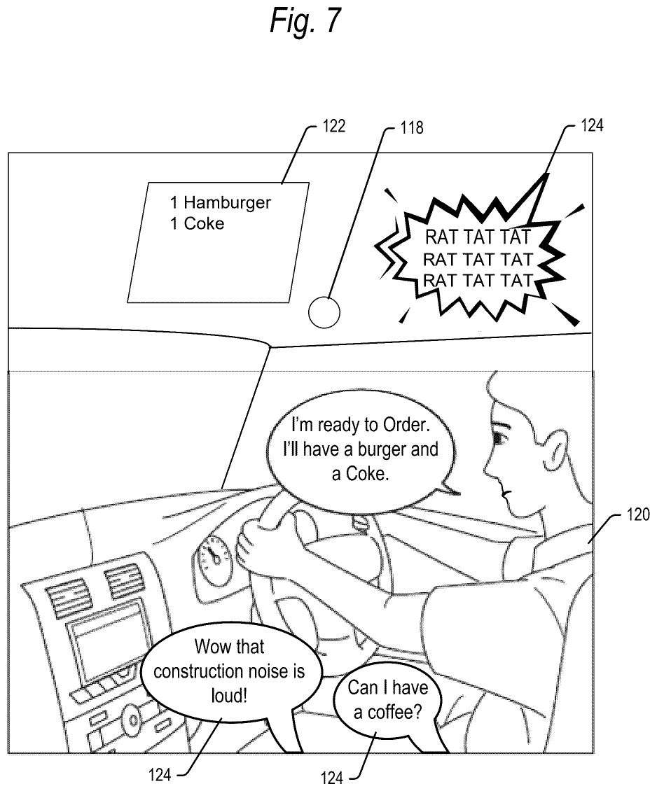

An example use-case of the operation of the audio prompt server 102 will now be explained with reference to the illustration of FIG. 7. In this example, a primary speaker (the driver) 120 is at a drive-through ordering location at a restaurant. The ordering location includes an audio/visual device 122 in the form of an order confirmation board (OCB) 122. FIG. 7 further shows several secondary audio sources 124 in the form of other speakers in the car, as well as ambient noise (loud construction in this example).

The microphone 118 picks up the audio from the target speaker 120, as well as from all of the secondary audio sources 124. However, using the present technology as described herein, the ordering system is able to filter out the secondary audio sources and focus on the target speaker's order. The present technology recognizes the target speakers utterance, determines a response, and displays that response on OCB 122 (in this case, accurately confirming the target speaker's order).

FIG. 8 illustrates an exemplary computing system 300 that may be server 102 or other server used to implement an embodiment of the present technology. The computing system 300 of FIG. 8 includes one or more processors 310 and main memory 320. Main memory 320 stores, in part, instructions and data for execution by processor unit 310. Main memory 320 can store the executable code when the computing system 300 is in operation. The computing system 300 of FIG. 8 may further include a mass storage device 330, portable storage medium drive(s) 340, output devices 350, user input devices 360, a display system 370, and other peripheral devices 380.

The components shown in FIG. 8 are depicted as being connected via a single bus 390. The components may be connected through one or more data transport means. Processor unit 310 and main memory 320 may be connected via a local microprocessor bus, and the mass storage device 330, peripheral device(s) 380, portable storage medium drive(s) 340, and display system 370 may be connected via one or more input/output (I/O) buses.

Mass storage device 330, which may be implemented with a solid state drive, a magnetic disk drive or an optical disk drive, is a non-volatile storage device for storing data and instructions for use by processor unit 310. Mass storage device 330 can store the system software for implementing embodiments of the present invention for purposes of loading that software into main memory 320.

Portable storage medium drive(s) 340 operate in conjunction with a portable non-volatile storage medium, such as a external hard drive, external SSD or USB stick, to input and output data and code to and from the computing system 300 of FIG. 8. The system software for implementing embodiments of the present invention may be stored on such a portable medium and input to the computing system 300 via the portable storage medium drive(s) 340.

Input devices 360 provide a portion of a user interface. Input devices 360 may include an alpha-numeric keypad, such as a keyboard, for inputting alpha-numeric and other information, or a pointing device, such as a mouse, a trackball, stylus, or cursor direction keys. Additionally, the system 300 as shown in FIG. 8 includes output devices 350. Suitable output devices include speakers, printers, network interfaces, and monitors. Where computing system 300 is part of a mechanical client device, the output device 350 may further include servo controls for motors within the mechanical device.

Display system 370 may include a liquid crystal display (LCD) or other suitable display device. Display system 370 receives textual and graphical information, and processes the information for output to the display device.

Peripheral device(s) 380 may include any type of computer support device to add additional functionality to the computing system. Peripheral device(s) 380 may include a modem or a router.

The components contained in the computing system 300 of FIG. 8 are those typically found in computing systems that may be suitable for use with embodiments of the present invention and are intended to represent a broad category of such computer components that are well known in the art. Thus, the computing system 300 of FIG. 8 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including UNIX, Linux, Windows, MacOS, FreeBSD, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, an SSD, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

In summary, one embodiment of the present technology relates to a system for recognizing speech of a target speaker in an environment comprising the target speaker and one or more secondary audio sources in addition to the target speaker, the system comprising: one or more audio prompt servers comprising one or more processors configured to: receive an audio prompt from the target speaker; determine from the audio prompt a target speaker fingerprint representing features of the target speaker audio; receive an audio stream from the target speaker and the one or more secondary audio sources; compare the audio stream to the target speaker fingerprint to isolate audio from the target speaker within the audio stream; and pass on the isolated audio from the target speaker for automatic speech recognition.

In another example, the present technology relates to a method of recognizing speech of a target speaker in an environment comprising the target speaker and one or more secondary audio sources in addition to the target speaker, the method comprising: (a) receiving an audio prompt from the target speaker; (b) determining from the audio prompt a target speaker fingerprint representing features of the target speaker audio received in said step (a); (c) receiving an audio stream from the target speaker and the one or more secondary audio sources after said step (b) of determining a target speaker fingerprint; (d) comparing the audio stream received in said step (c) to the target speaker fingerprint determined in said step (b) to isolate audio from the target speaker within the audio stream; and (e) performing automatic speech recognition on the isolated audio from the target speaker.

In a further example, the present technology relates to a drive-through system for recognizing speech of a target speaker placing an order in an environment comprising the target speaker and one or more secondary audio sources in addition to the target speaker, the drive-through system comprising: a microphone for receiving audio from the target speaker and one or more secondary audio sources; one or more audio prompt servers comprising one or more processors configured to: receive via the microphone an audio prompt from the target speaker; determine from the audio prompt a target speaker fingerprint representing features of the target speaker audio; receive an audio stream from the target speaker and the one or more secondary audio sources; compare the audio stream to the target speaker fingerprint to isolate audio from the target speaker within the audio stream; and pass on the isolated audio from the target speaker for automatic speech recognition and fulfillment of the target speaker order.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

We claim:

1. A system for recognizing speech of a target speaker in an environment comprising the target speaker and one or more secondary audio sources in addition to the target speaker, the system comprising:
one or more audio prompt servers comprising one or more processors configured to:
receive an audio prompt from the target speaker;
determine from the audio prompt a target speaker fingerprint representing features of the target speaker audio;
receive an audio stream from the target speaker and the one or more secondary audio sources;
compare the audio stream to the target speaker fingerprint to isolate audio from the target speaker within the audio stream; and
pass on the isolated audio from the target speaker for automatic speech recognition.

2. The system of claim 1, wherein the audio prompt comprises 3 or more seconds of audio from the target speaker.

3. The system of claim 1, wherein the audio prompt comprises a stream of uninterrupted audio from the target speaker.

4. The system of claim 1, wherein the server comprises an automatic speech recognition engine implemented by the one or more processors to recognize and transcribe the isolated audio of the target speaker.

5. The system of claim 1, wherein the server comprises a natural language unit engine implemented by the one or more processors to discern a meaning of the isolated audio of the target speaker.

6. The system of claim 1, further comprising a target speaker fingerprint extraction engine implemented by the one or more processors for determining the target speaker fingerprint.

7. The system of claim 1, further comprising a target speaker mask extraction engine implemented by the one or more processors for determining a mask used to isolate the audio from the target speaker from the audio stream.

8. The system of claim 1, further comprising an input audio feature extraction engine implemented by the one or more processors for receiving and processing the input audio stream into an audio feature stream, wherein the audio feature stream is compared to the target speaker fingerprint to isolate audio from the target speaker within the audio stream.

9. The system of claim 1, wherein the secondary source of audio is one or more people whose audio is captured with the target speaker.

10. The system of claim 1, wherein the secondary source of audio is environmental or ambient noise.

11. The system of claim 1, wherein the one or more audio prompt servers are used to take an order from the target speaker at a drive-through establishment.

12. The system of claim 1, wherein the one or more audio prompt servers are used to support conference calls including the target speaker.

13. A method of recognizing speech of a target speaker in an environment comprising the target speaker and one or more secondary audio sources in addition to the target speaker, the method comprising:
(a) receiving an audio prompt from the target speaker;
(b) determining from the audio prompt a target speaker fingerprint representing features of the target speaker audio received in said step (a);
(c) receiving an audio stream from the target speaker and the one or more secondary audio sources after said step (b) of determining a target speaker fingerprint;
(d) comparing the audio stream received in said step (c) to the target speaker fingerprint determined in said step (b) to isolate audio from the target speaker within the audio stream; and
(e) performing automatic speech recognition on the isolated audio from the target speaker.

14. The method of claim 13, wherein said step (b) comprises the step of employing emphasized channel attention, propagation, and aggregation to determine the target speaker fingerprint.

15. The method of claim 13, wherein said step (b) comprises the step of processing the audio prompt received in said step (a) into a time-frequency domain representation of the target speaker audio prompt.

16. The method of claim 13, wherein said step (b) comprises the step of processing the audio prompt received in said step (a) into a logarithmically scaled Mel spectrogram of the target speaker audio prompt.

17. The method of claim 13, further comprising the step of processing the audio stream received in said step (c) into a time-frequency domain representation of the audio stream.

18. The method of claim 17, wherein said step (d) of comparing the audio stream received in said step (c) to the target speaker fingerprint determined in said step (b) further comprises the step of comparing the time-frequency domain representation of the audio stream against the target speaker fingerprint.

19. The method of claim 13, wherein said step (d) of comparing the audio stream received in said step (c) to the target speaker fingerprint determined in said step (b) further comprises the step of deriving a mask using a neural network, which mask is configured to suppress all audio in the audio stream other than a voice of the target speaker.

20. A drive-through system for recognizing speech of a target speaker placing an order in an environment comprising the target speaker and one or more secondary audio sources in addition to the target speaker, the drive-through system comprising:
a microphone for receiving audio from the target speaker and one or more secondary audio sources;
one or more audio prompt servers comprising one or more processors configured to:
receive via the microphone an audio prompt from the target speaker;
determine from the audio prompt a target speaker fingerprint representing features of the target speaker audio;
receive an audio stream from the target speaker and the one or more secondary audio sources;
compare the audio stream to the target speaker fingerprint to isolate audio from the target speaker within the audio stream; and
pass on the isolated audio from the target speaker for automatic speech recognition and fulfillment of the target speaker order.
